(19) United States
(12) Patent Application Publication
(10) Pub. No.: US 2020/0263348 A1
(43) Pub. Date: Aug. 20, 2020

(54) REINFORCED COMPOSITE MATERIAL WITH IMPROVED MECHANICAL AND THERMAL PROPERTIES AND METHOD FOR OBTAINING THE SAME

(71) Applicants: Consejo Nacional de Investigaciones Cientificas y Técnicas (CONICET), Ciudad Autónoma de Buenos Aires (AR); IIndumentaria Protectiva RASA SA Agencia En Chile, Santiago de Chile (CL)

(72) Inventors: Eugenio Hernan OTAL, Buenos Aires (AR); Manuela Leticia KIM, Buenos Aires (AR)

(21) Appl. No.: 16/639,910

(22) PCT Filed: Aug. 20, 2018
(86) PCT No.: PCT/IB2018/056278

§ 371 Date: Feb. 18, 2020

Related U.S. Application Data
(60) Provisional application No. 62/547,459, filed on Aug. 18, 2017.

(51) Int. Cl. D06M 11/79; C08J 3/24; C08G 83/00; C08B 15/10; D06N 3/12

(52) U.S. Cl. CPC D06M 11/79; C08J 3/245; D06M 2101/06; C08B 15/10; D06N 3/128; C08G 83/001

(57) ABSTRACT

The present invention relates to a reinforced composite material, comprising an organic polymer, a silicon polymer, and an interphase between said organic polymer and said silicon polymer, wherein said interphase comprises chemical bonds between the organic polymer and the silicon polymer, and to a method to obtain said reinforced composite material. The present disclosure can be used to improve the mechanical properties of silica aerogels by functionalization of textile materials.

### CROSS-REFERENCE TO RELATED APPLICATIONS

This application claims the benefit of U.S. Provisional Application No. 62/547,549 filed Aug. 18, 2017, the disclosure of which is incorporated herein by reference in its entirety.

### FIELD OF THE INVENTION

The present invention relates to the field of thermally insulating materials, in particular silica aerogels and to methods of improving the mechanical properties thereof

### BACKGROUND OF THE INVENTION

The use of silica aerogels as thermal insulators is justified by its advantageous properties, namely low thermal conductivity, high thermal resistance and low weight as compared to ceramic materials. However, they exhibit poor mechanical properties, in particular a very low resistance to mechanical stress. This can be attributed to both their chemical structure that is close to that of glass, and their high porosity characteristics.

In order to improve mechanical properties, the inclusions of siloxanes, i.e. organic molecules with Si—O—Si bonds, have proved to be a viable alternative. Siloxanes are the main component in silicone sealers and kitchen utensils, which are flexible and resistant to high temperatures.

Even though an increase in flexibility allows for an increase in the possible uses of silica, there is still a number of uses that cannot yet be implemented. In order to improve the mechanical properties even further and permit their use in textiles, where flexion is a key factor, a possible solution is to reinforce the aerogels with textile fibers, obtaining composite materials.

Several works describe composites consisting essentially of aerogels reinforced with textile fabrics. Chakraborty et al. reinforced flexible aerogels with Nomex (Chakraborty et al., Synthesis and Characterization of Fiber Reinforced Silica Aerogel Blankets for Thermal Protection, Advances in Materials Science and Engineering, 2016, DOI: 10.1155/2016/2495623), Li et al. reinforced aerogels with aramids (Li et al., Flexible silica aerogel composites strengthened with aramid fibers and their thermal behavior, Materials & Design, 2016, DOI: 10.1016/j.matdes.2016.03.063 and Li at al., Aramid fibers reinforced silica aerogel composites with low thermal conductivity and improved mechanical performance, Composites Part A: Applied Science and Manufacturing, 2016, DOI: 10.1016/j.compositesa.2016.02.014), Rezaei et al. reinforced aerogels with cotton (Rezaei et al., Thermal Conductivities Of Silica Aerogel Composite Insulating Material, Advanced Material Letters, 2016, DOI: 10.5185/amlett.2016.6178). In addition, U.S. Patent Application Publication No. 2007/0154698 A1 discloses the reinforcement of aerogels with fibers.

To the present, aerogels have provided thermal insulation, flexibility, and some degree of reinforcement for use in textiles. However, durability with intensive use, washing, and mechanical protection require a strong adhesion between the materials of the composite.

There is thus a need to provide a better, stronger chemical union between the materials of the fiber-reinforced aerogel.

### SUMMARY OF THE INVENTION

It is therefore an object of the present invention to provide a stronger chemical union between the components of a composite material obtained by functionalization of textile materials with silicon polymers (e.g., silica aerogels).

The strategy described herein is to obtain an interphase between the textile and the silicon polymer (e.g., aerogel), in order to improve adhesion between the textile and the silicon polymer (e.g., aerogel). An interphase comprises one or more covalent bonds and/or one or more hydrogen bonds between the textile and the silicon polymer (e.g., aerogel).

In the case of employing cotton as a textile material, said interphase comprises C—O—Si covalent bonds between cellulose units and silanols, e.g., silanols obtained from the hydrolysis of a silicon compound such as, for example, a silicon alkoxide, silicon alkylalkoxide, and the like, and combinations thereof.

In the case of employing textiles with organic moieties which can produce amine (—NH₂) or alcohol (—OH) groups by hydrolysis, e.g., polyamides (e.g., aliphatic polyamides, aramids, and the like), polyurethanes, polyesters (e.g., aromatic and aliphatic polyesters), and the like, as a textile material, said interphase comprises hydrogen bond unions between —NH₂ and/or —OH groups on a fiber surface and silanol groups. R—H₂N . . . HO—Si bonds and R—OH . . . HO—Si bonds are examples of such interphase components, where R is the remainder of a fiber. For example, amino groups can be formed by hydrolysis of amide bonds of, for example, aramid or aromatic polyamide fibers. In an example, a polyamide is a polyphthalamide. For example, hydroxyl groups can be formed by hydrolysis of ester bonds of, for example, polyester fibers, or are naturally-present in the textile (e.g., cotton textiles).

The strength of the present chemical modification relies in the increase of the chemical interaction between fibers and the aerogel functionalization with the fibers. The incorporation of hydrogen bonds and/or covalent bonds reinforces the mechanical stability of the aerogel functionalization.

It is therefore an object of the present invention to provide a reinforced composite material, comprising: an organic polymer; a silicon polymer; and an interphase between said organic polymer and said silicon polymer, wherein said interphase comprises chemical bonds (e.g., one or more covalent bonds and/or one or more hydrogen bonds) between the organic polymer and the silicon polymer.

In a preferred embodiment of the reinforced composite material, the organic polymer is a textile material. In another preferred embodiment of the reinforced composite material, the textile material is selected from the group consisting of cotton, polyamide fibers (e.g., aramid fibers), polyester fibers, polyurethane fibers, and the like, and combinations thereof.

In yet another preferred embodiment of the reinforced composite material, the textile material comprises/is a polyamide fiber (e.g., aliphatic, semi-aromatic, fully aromatic polyamides or a combination thereof) and the chemical bonds between the organic polymer and the silicon polymer comprise R—H₂N . . . HO—Si hydrogen bonds and/or R—OH . . . HO—Si bonds, where R is remainder of the polymer, between the surface —NH₂ or —OH groups of the fibers and the Si—OH groups of the silicon polymer. Non-limiting examples of polyamide fibers include nylons and the like. Other non-limiting examples of aromatic polyamides include Nomex, Kevlar (Dupont), Technora, Heracron, Twaron, and the like.

In a preferred embodiment of the reinforced composite material, the textile material comprises/is cotton and the chemical bonds between the organic polymer and the silicon polymer comprises C—O—Si covalent bonds between the cellulose of the cotton fibers and the Si—OH groups of the silicon polymer.

In a preferred embodiment of the reinforced composite material, the textile material comprises/is a polyurethane, polyester, or polyamide fiber the chemical bonds between the organic polymer and the silicon polymer comprise R—H₂N . . . HO—Si or R—OH . . . HO—Si hydrogen bonds, where R is remainder of the polyamide, polyester or polyurethane polymer, between the hydrolyzed —NH₂ or —OH groups of the fiber(s) and the Si—OH groups of the silicon polymer.

In another preferred embodiment of the reinforced composite material, the silicon polymer is a silica aerogel.

It is another object of the present invention to provide a method to obtain a reinforced composite material, comprising:
providing an organic polymer;
providing a silicon polymer precursor; and
obtaining a silicon polymer from the silicon polymer precursor and an interphase between said organic polymer and a silicon polymer, wherein said interphase comprises chemical bonds between said organic polymer and said silicon polymer.

In a preferred embodiment of the method to obtain a reinforced composite material, the organic polymer is a textile fabric and the step of obtaining an interphase between said organic polymer and said silicon polymer further comprises contacting (e.g., washing) said textile fabric with a mixture comprising a basic compound (e.g., metal hydroxides, such as, for example, sodium hydroxide, potassium hydroxide, and the like, tetramethylammonium hydroxide, DABCO, and the like) and contacting (e.g., pretreating) said fabric with a mixture comprising a silicon compound.

It is desirable to use a strong basic compound. In an example, the basic compound(s) provide/provides a mixture (e.g., a solution in water) having a pH of 8-14, including all 0.1 pH values and ranges therebetween. In various examples, the basic compound(s) provide/provides a mixture (e.g., a solution in or comprising water) having a pH of at least 8, at least 8.5, at least 9, at least 9.5, at least 10, at least 10.5. In various examples, the basic compound(s) provide/provides a mixture (e.g., a solution in or comprising water) having a pH of at least 8, at least 8.5, at least 9, at least 9.5, at least 10, at least 10.5 at a temperature of about room temperature (e.g., 18-25° C.) to about 200° C., including all integer ° C. values and ranges therebetween.

The methods (e.g., the contacting, such as, for example, washing) are carried out at (e.g., in a mixture having a) pH of 8-14, including all 0.1 pH values and ranges therebetween. In various examples, the methods (e.g., the contacting, such as, for example, washing) are carried out at (e.g., in a mixture having a) pH of at least 8, at least 8.5, at least 9, at least 9.5, at least 10, at least 10.5. In various examples, the methods (e.g., the contacting, such as, for example, washing) are carried out at (e.g., in a mixture having a) at least 8, at least 8.5, at least 9, at least 9.5, at least 10, at least 10.5 at a temperature of a temperature of about room temperature (e.g., 18-25° C.) to about 200° C., including all integer ° C. values and ranges therebetween.

The mixture may comprise a basic compound and one or more solvents. In an example, the solvent comprises/is water. In various examples, the solvent comprises water and/or one or more alcohols.

The time, concentration of basic compound(s), and temperature of the contacting (e.g., washing) are correlated. For example, higher temperature and/or concentration generally means shorter times.

It may be desirable that contacting (e.g., washing) the textile with the mixture comprising a basic compound provides only surface —NH₂ and/or —OH groups and does not degrade the fiber. In an example, the contacting (e.g., washing) the textile with the mixture comprising a basic compound provides only surface —NH₂ and/or —OH groups.

It is desirable that contacting (e.g., washing) the textile with the mixture comprising a basic compound does not substantially affect one or more mechanical property of the textile. In an example, one or more of the mechanical properties of the textile after being contacted with the mixture comprising a basic compound is the same or substantially the same (e.g., changed by 5% or less, 4% or less, 3% or less, 2% or less, 1% or less) compared to same mechanical property(ies) of the a textile having the same composition (e.g., the same textile) that has not been being contacted with the mixture.

In another preferred embodiment of the method to obtain a reinforced composite material, the organic polymer is a polyamide fiber. Examples of polyamides include, but are not limited to, aliphatic, aromatic, and semi-aromatic polyamides and combinations thereof. Non-limiting examples of polyamides include nylon materials. Aramids are examples of aromatic polyamides.

In yet another preferred embodiment of the method to obtain a reinforced composite material, the organic polymer is an aramid fiber.

In still another preferred embodiment of the method to obtain a reinforced composite material, the organic polymer is a polyurethane fiber.

In still another preferred embodiment of the method to obtain a reinforced composite material, the organic polymer is a polyester fiber.

In still another preferred embodiment of the method to obtain a reinforced composite material, the organic polymer is a polyamide fiber.

In still another preferred embodiment of the method to obtain a reinforced composite material, the organic polymer is a cotton fiber.

In a preferred embodiment of the method to obtain a reinforced composite material, the basic compound is sodium hydroxide and the silicon compound is a silicon alkoxide. The silicon alkoxide may be a partially alkylated silicon alkoxide. For example, the number of carbons in the alkyl portion of the alkoxide being, independently, for example, 1, 2, 3, 4, 5, or any the amount that can be partially hydrolyzed. In an example, the silicon alkoxide (e.g., partially hydrolyzed silicon alkoxide) does not precipitate before the application on the textile and/or can form a covalent of hydrogen bond with the pre-hydrolyzed fibers.

In another preferred embodiment of the method to obtain a reinforced composite material, the silicon alkoxide is tetraethyl orthosilicate and/or tetramethyl orthosilicate.

In another preferred embodiment of the method to obtain a reinforced composite material, the silicon-containing compound is a silicate (e.g., sodium silicate). In yet another preferred embodiment of the method to obtain a reinforced composite material, the step of obtaining silicon polymer from the silicon polymer precursor comprises polymerizing the silicon polymer precursor.

In still another a preferred embodiment of the method to obtain a reinforced composite material, the step of polymerizing the silicon polymer precursor comprises steps of hydrolysis of the silicon polymer precursor, condensation, and thermal treatment (e.g., heating, such as, for example, curing).

In a preferred embodiment of the method to obtain a reinforced composite material, the method further includes a step of drying.

In another preferred embodiment of the method to obtain a reinforced composite material, the method is carried out at a temperature of about room temperature (e.g., 18-25° C.) to about 200° C., including all integer ° C. values and ranges therebetween.

In a preferred embodiment of the method to obtain a reinforced composite material, the silicon polymer precursor comprises an alkyltrialkoxysilane, dialkyldialkoxysilane, trialkylalkoxysilane, or a combination thereof. In various examples, the number of carbons in the alkyl group and/or alkyl portion of the alkoxide (R) being, independently, for example, 1, 2, 3, 4, 5, or any the amount that can be partially hydrolyzed. In an example, the partially hydrolyzed alkyltrialkoxysilane does not precipitate before the application on the textile and/or can form a covalent of hydrogen bond with the pre-hydrolyzed fibers.

In yet another preferred embodiment of the method to obtain a reinforced composite material, the alkyltrialkoxisilane is methyltriethoxysilane.

The alkyl group in a tetraalkoxysilane or alkyltrialkoxysilane plays a role of improving the hydrogen bonds formed by and van der Waals interactions of the alkyltrialkoxysilane. The length of the alkyl group and alkyl portion of the alkoxy groups effect the relative hydrolysis rate and condensation rate of the tetraalkoxysilane or alkyltrialkoxysilane.

### BRIEF DESCRIPTION OF THE DRAWINGS

FIG. 1 shows the Fourier transform infrared spectroscopy (FTIR) spectrum of the untreated aramid fiber sample.

FIG. 2 shows the ratio of FTIR spectrum bands corresponding to the aliphatic chain (823 cm⁻¹) and the amides (1647 cm⁻¹) of aramid fiber samples.

FIG. 3 shows the results of transversal traction tests carried out on aramid fiber samples prepared with different surface preparation treatments as described herein.

FIG. 4 shows the results of longitudinal traction tests carried out on aramid fiber samples prepared with different surface preparation treatments.

FIG. 5 shows examples of polyamide hydrolysis, polyester hydrolysis, and polyurethane hydrolysis.

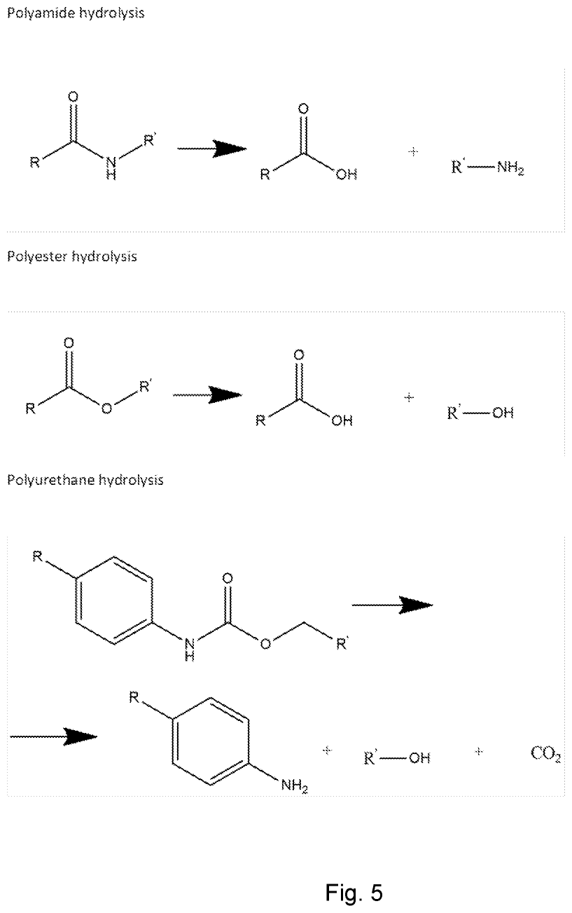

### DETAILED DESCRIPTION OF THE INVENTION

The invention will be described in further detail with reference to the appended figures and examples.

As used herein, the term “silica aerogel” refers to a non-fluid ultralight silica polymer network dispersed in a gas such as air. When the polymerized precursor of silica is gelified in an alcoholic solvent, such as methanol or ethanol, the term “silica alcogel” is usually employed.

In general, the term “silicon precursor” or “silicon polymer precursor” refers to a compound from which a silicon polymer can be obtained.

As used herein, the term “textile” or “textile material” refers to a flexible material consisting of a network of woven or unwoven, natural or synthetic fibers.

As used herein, the term “reinforced” refers to material with one or more enhanced properties (e.g., increased physical properties, increased thermal resistance, enhanced adhesion between materials in a composite, etc.)

With the method described herein, the inventors were able to generate an interphase between the textile and the aerogel. Said interphase comprises silanol groups which are chemically bonded to the textile, by means of covalent bonds in the case of cotton and hydrogen bonds in the case of polyamides (e.g., aramids), and that allows the growth of a silica aerogel on said interphase, where the aerogel comprises Si—O—Si covalent bonds.

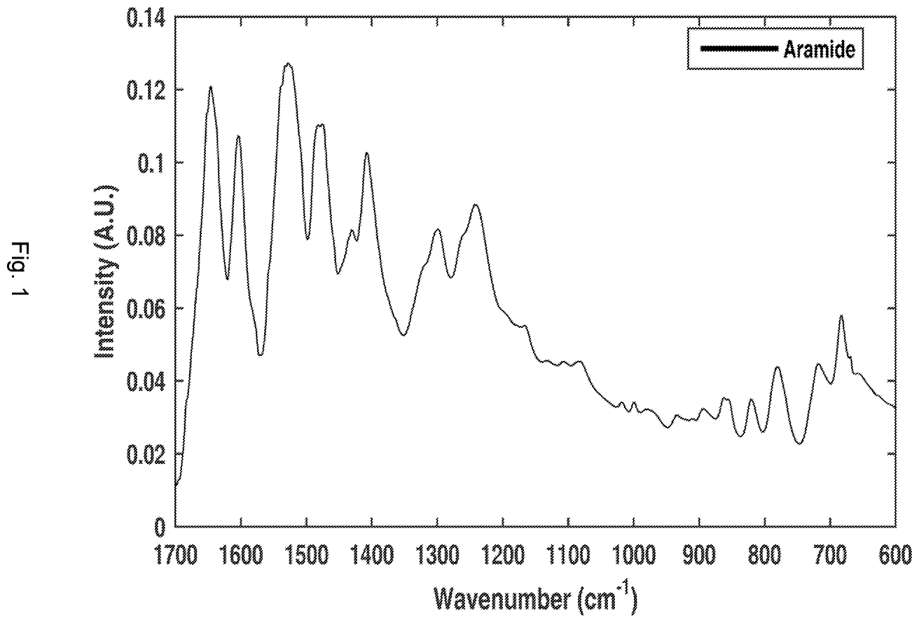

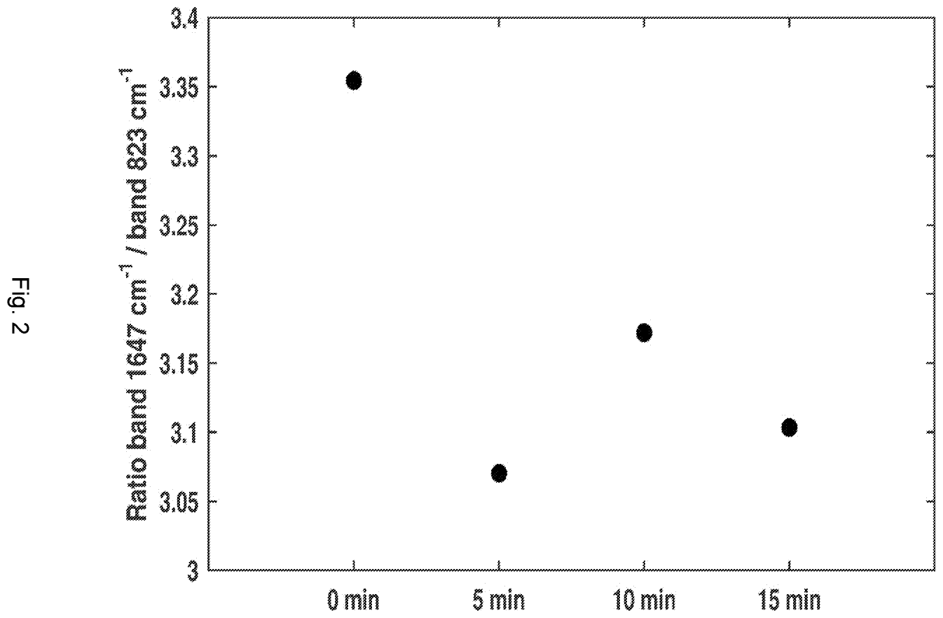

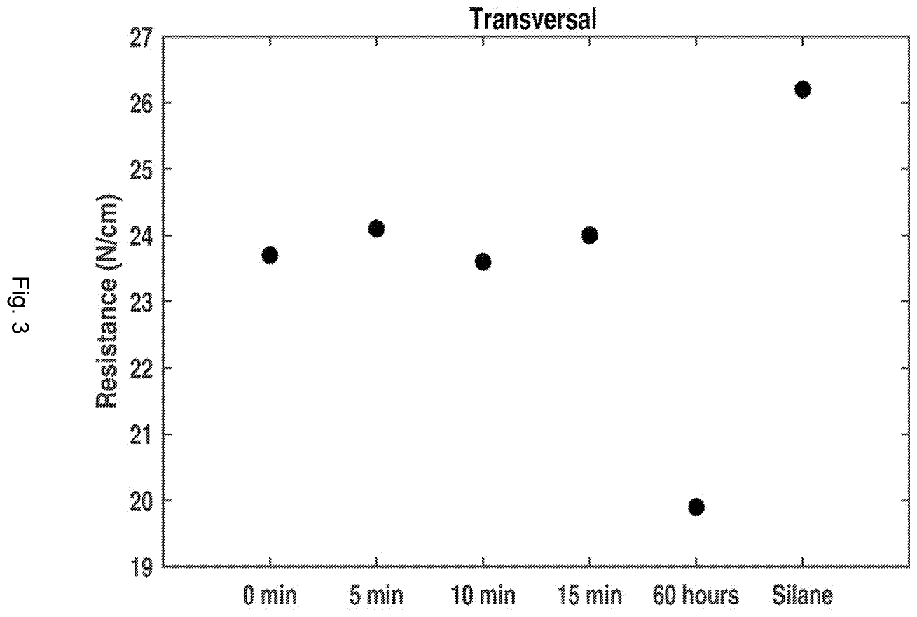

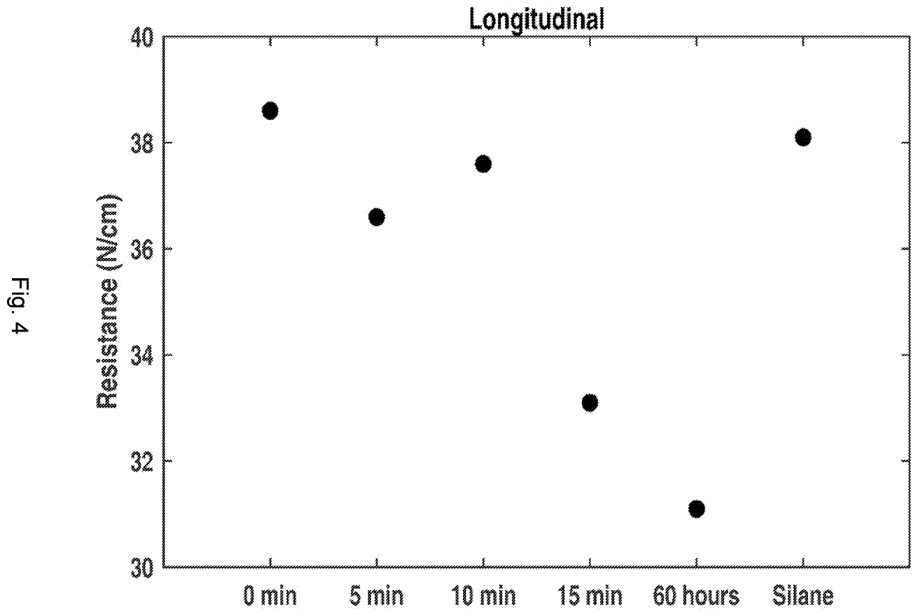

In the case of polyamides (e.g., aramids), the textile fibers were treated by washing in a strong basic medium to generate a hydrolysis of the amide groups, resulting in surface —NH₂ groups, as it can be seen in FIGS. 1 and 2. Said amine functional groups can interact with the Si—OH groups (for example, by hydrogen bonding). For reaction times of around 10 min (minutes), this surface hydrolysis treatment did not result in a decreased mechanical resistance of the obtained composite materials, as evidenced in the tests shown in FIGS. 3 and 4. In the case of cotton, surface treatment was not needed, since the —OH groups in cellulose have sufficient reactivity to react with silicon precursors or silanols.

In the case of cotton, covalent C—O—Si bonds are formed between cellulose units and silanols. In the case of polyamides (e.g., aramids) and polyurethanes, a hydrogen bond is formed between surface NH₂ groups and Si—OH groups, with R—H₂N.HO—Si bonds.

The generated interphase, containing the aforementioned bonds, acts as an intermediary that allows the bonding of an organic polymer (e.g., natural or synthetic or a combination thereof) with a silicon polymer (e.g., an aerogel).

The obtained composite materials have a global structure, for example, given by (textile//surface groups in the textile from the hydrolysis process//surface silanol groups//aerogel), which confers the material the ability to withstand undesirable (e.g., severe) conditions and the possibility to be washed in order to remove pollutants, without a decrease in the thermal insulation properties.

The silicon polymer (e.g., aerogel) can be formed using various silicon compounds. Mixtures of silicon compounds can be used. For example, the silicon compound is a silicon alkoxide (e.g., a tetraalkoysilane). The silicon alkoxide may be a partially or completely alkylated silicon alkoxide. For example, the number of carbons in the alkyl portion of the alkoxide group being, for example, 1, 2, 3, 4, 5, or any the amount that can be partially hydrolyzed. In an example, the silicon alkoxide (e.g., partially hydrolyzed silicon alkoxide does not precipitate before the application on the textile and/or can form a covalent of hydrogen bond with the pre-hydrolyzed fibers. In another preferred embodiment of the method to obtain a reinforced composite material, the silicon alkoxide is tetraethyl orthosilicate and/or tetramethyl orthosilicate. In another preferred embodiment of the method to obtain a reinforced composite material, the silicon-containing compound is a silicate (e.g., sodium silicate).

The silicon polymer (e.g., aerogel) can have various thicknesses and fiber coverages. In an example, silicon polymer (e.g., aerogel) has a thickness (e.g., a dimension perpendicular to a surface of a fiber) of 1-100 nm, including all nm values and ranges therebetween. The silicon polymer (e.g., aerogel) may be a continuous or discontinuous layer disposed on a fiber surface.

The steps of the method described in the various embodiments and examples disclosed herein are sufficient to carry out the method of the present disclosure. Thus, in an embodiment, the method consists essentially of a combination of the steps of the method disclosed herein. In another embodiment, the method consists of such steps.

The following examples are presented to illustrate the present disclosure. They are not intended to limiting in any matter.

### EXAMPLES

Washing of the Fiber Samples.

Preparation of Cotton Fibers

A washing solution was prepared by dissolving 5.0 g of NaOH in 20 mL of water. 1.5 g of Triton X-100 and 0.75 g of citric acid were added and the solution was completed with water to 500 mL.

The sample was covered with the washing solution and stirred at 100° C. for 1 h (h=hour(s)). The solution was removed, the sample was rinsed with water and air-dried.

Preparation of Aramid Fibers.

Aramid fiber samples were treated with NaOH at 10% (prepared with 10 g of NaOH in 100 mL of distilled water) for 10 min. The samples were washed with excess, neutralized with HCl at 0.1 mol/L, then re-washed with water.

Pretreatment of the Fibers with Silanols.

The washed samples were immersed in a 2% tetraethyl orthosilicate (TEOS) in an ethanol/water 80:20 mixture. The sample was recovered, thermally treated at 110° C. for 2 h and washed with ethanol.

Preparation of Silica Aerogels.

The silica alcogels were prepared via precursor hydrolysis and condensation, curing and subsequent drying at ambient pressure. Typically, the molar relation methyltriethoxysilane (MTES):methanol:oxalic acid (0.001 mol/L):NH₃ (10 mol/L) is 1:27:4:4.

Precursor hydrolysis: 4 mL of MTES were mixed with 22.4 mL of methanol, 1.48 mL of oxalic acid solution (0.001 mol/L) were added. The resulting mixture was stirred for 24 h.

Condensation: After precursor hydrolysis, 0.36 g of silanol terminated polydimethylsiloxane (PDMS) and 1.48 mL NH₃ (10 mol/L) were added dropwise and the resulting mixture was stirred for 2 h.

Subsequently, the fabrics treated with silanols were soaked with these alcoholic sols. The wet samples were cured in a furnace for 2 days at 50° C., and then washed with ethanol every 12 h, repeating twice.

Thereafter, the wet gels were dried at atmospheric pressure in a three-stage furnace, at 50° C. for 12 h, 80° C. for 2 h and finally at 200° C. for 2 h.

What is claimed is:

1. A reinforced composite material, comprising:
an organic polymer;
a silicon polymer; and
an interphase between said organic polymer and said silicon polymer, wherein said interphase comprises chemical bonds between the organic polymer and the silicon polymer.

2. The reinforced composite material according to claim 1, wherein the organic polymer is a textile material.

3. The reinforced composite material according to claim 2, wherein the textile material is selected from the group consisting of cotton, polyamide fibers, polyester fibers and polyurethane fibers.

4. The reinforced composite material according to claim 3, wherein the polyamide fiber is an aramid fiber.

5. The reinforced composite material according to any one of claims 1-4, wherein the chemical bonds between the organic polymer and the silicon polymer comprise R—H₂N . . . HO—Si hydrogen bonds between the surface NH₂ groups of the polyamide fibers or polyurethane fibers and the Si—OH groups of the silicon polymer or —OH . . . HO—Si hydrogen bonds between the surface —OH groups of the polyester fibers and the Si—OH groups of the silicon polymer, where R is the remainder of the fiber.

6. The reinforced composite material according to any one of claims 1-3, wherein the textile material is cotton and the chemical bonds between the organic polymer and the silicon polymer comprise C—O—Si covalent bonds between the cellulose of the cotton fibers and the Si—OH groups of the silicon polymer.

7. The reinforced composite material according to any one of the preceding claims, wherein the silicon polymer is a silica aerogel.

8. A method to obtain a reinforced composite material, the method comprising:
providing an organic polymer;
providing a silicon polymer precursor; and
obtaining a silicon polymer from the silicon polymer precursor and an interphase between said organic polymer and a silicon polymer, wherein said interphase comprises chemical bonds between said organic polymer and said silicon polymer.

9. The method to obtain a reinforced composite material according to claim 8, wherein the organic polymer is a textile fabric and the step of obtaining an interphase between said organic polymer and said silicon polymer further comprises washing said textile fabric with a mixture comprising a basic compound and pretreating said fabric with a mixture comprising a silicon compound.

10. The method to obtain a reinforced composite material according to claim 8 or 9, wherein the organic polymer is a polyamide fiber or a polyurethane fiber.

11. The method to obtain a reinforced composite material according to claim 10, wherein the organic polymer is an aramid fiber.

12. The method to obtain a reinforced composite material according to claim 8, wherein the organic polymer is a cotton fiber.

13. The method according to any one of claims 8 to 12, wherein the basic compound is sodium hydroxide and the silicon compound is a silicon alkoxide.

14. The method according to claim 13, wherein the silicon alkoxide is tetraethyl orthosilicate.

15. The method to obtain a reinforced composite material according to claims 8 to 14, wherein the step of obtaining silicon polymer from the silicon polymer precursor comprises polymerizing the silicon polymer precursor.

16. The method to obtain a reinforced composite material according to claim 15, wherein the polymerizing the silicon polymer precursor comprises hydrolyzing the silicon polymer precursor, condensing the hydrolyzed silicon polymer precursor, and curing the condensed hydrolyzed silicon polymer precursor.

17. The method to obtain a reinforced composite material according to claim 15 or 16, wherein the method further includes drying.

18. The method to obtain a reinforced composite material according to claims 15 to 17, wherein the method is carried out at a temperature from about room temperature to about 200° C.

19. The method according to any one of claims 8 to 18, wherein the silicon polymer precursor comprises an alkyltrialkoxisilane.

20. The method according to claim 19, wherein the alkyltrialkoxisilane is methyltriethoxysilane.
